(19) United States
(12) Patent Application Publication
(10) Pub. No.: US 2014/0160253 A1
(43) Pub. Date: Jun. 12, 2014

(54) HYPERSPECTRAL IMAGER

(71) Applicant: MICROSOFT CORPORATION, Redmond, WA (US)

(72) Inventors: Terje K. Backman, Carnation, WA (US); Michael Aksionkin, Redmond, WA (US)

(73) Assignee: MICROSOFT CORPORATION, Redmond, WA (US)

(21) Appl. No.: 13/709,911

(22) Filed: Dec. 10, 2012

(51) Int. Cl. G02B 5/20; H04N 13/02

(52) U.S. Cl. CPC G02B 5/201; H04N 13/0242
USPC 348/48; 250/226

(57) ABSTRACT

A hyperspectral imager includes a sensor array and a filter array. The sensor array is an array of individually addressable sensor elements, each element responsive to radiant energy received thereon. The filter array is arranged to filter the radiant energy en route to the sensor array. It includes an inhomogeneous tiling of first and second filter elements, with the first filter element transmitting radiant energy of an invisible wavelength band and rejecting radiant energy of a visible wavelength band. The second filter element transmits radiant energy of the visible wavelength band and rejects radiant energy of the invisible wavelength band.

### BACKGROUND

The sensor array of a digital camera may be configured to image only those wavelengths of light that are visible to the human eye. However, certain video and still-image applications require hyperspectral imaging of a subject—imaging that extends into the ultraviolet (UV) or infrared (IR) regions of the electromagnetic spectrum. For these applications, one approach has been to acquire component images of the same subject with different sensor arrays—one sensitive to the visible and another to the IR, for example—and then to co-register and combine the component images to form a hyperspectral image.

The approach summarized above admits of numerous disadvantages. First and foremost, it requires at least two different sensor arrays. Second, it requires accurate positioning of the sensor arrays relative to each other, and/or image processing to co-register the component images. Third, the combined image may exhibit parallax distortion due to the offset between the sensor arrays. In some cases, beam-splitting technology may be used to eliminate the parallax error, but that remedy requires additional optics and additional accurate alignment, and may reduce the signal-to-noise ratio of both sensor arrays.

### SUMMARY

Accordingly, one embodiment of this disclosure provides a hyperspectral imager having a sensor array and a filter array. The sensor array is an array of individually addressable sensor elements, each element responsive to radiant energy received thereon. The filter array is arranged to filter the radiant energy en route to the sensor array. It includes an inhomogeneous tiling of first and second filter elements, with the first filter element transmitting radiant energy of an invisible wavelength band and rejecting radiant energy of a visible wavelength band. The second filter element transmits radiant energy of the visible wavelength band and rejects radiant energy of the invisible wavelength band.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows aspects of an example imaging system in accordance with an embodiment of this disclosure.

FIG. 2 shows aspects of an example radiant-energy source in accordance with an embodiment of this disclosure.

FIG. 3 shows aspects of an example hyperspectral imager in accordance with an embodiment of this disclosure.

FIG. 4 shows aspects of sensor and filter arrays of an example hyperspectral imager, in accordance with an embodiment of this disclosure.

FIGS. 5A and 5B show idealized transmittance spectra of filter arrays having low-pass, high-pass, and band-pass filter elements, in accordance with embodiments of this disclosure.

FIG. 6 shows aspects of a filter array with triangular filter elements in accordance with an embodiment of this disclosure.

FIG. 7 shows aspects of a filter array with hexagonal filter elements in accordance with an embodiment of this disclosure.

FIGS. 8 and 9 show aspects of a filter array having five different filter elements in accordance with embodiments of this disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

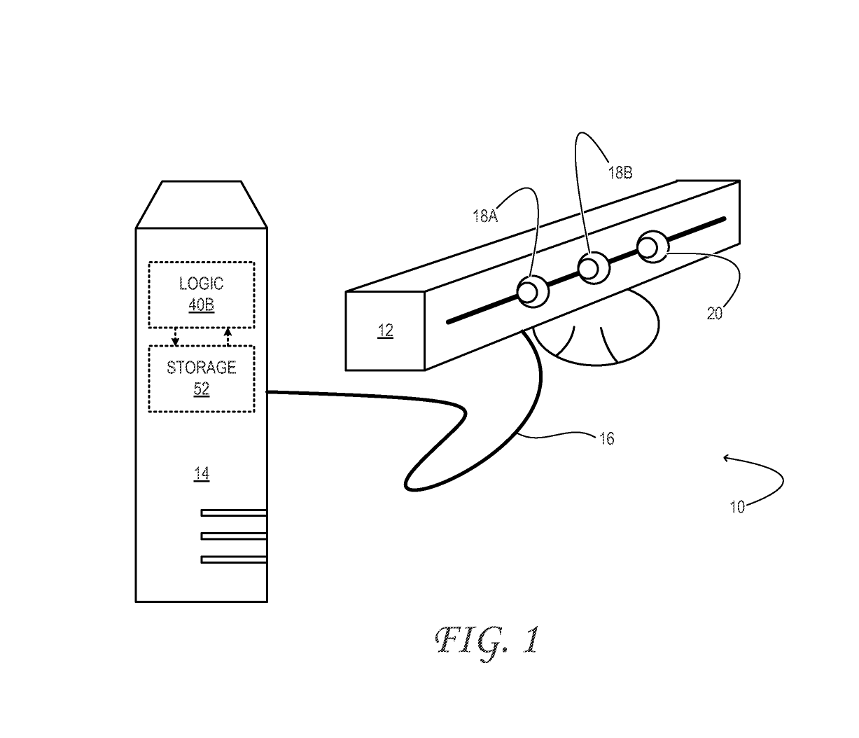

FIG. 1 shows aspects of an example imaging system 10 in one embodiment. The imaging system includes camera 12 and computer 14. The camera is configured to acquire an image of a subject (not shown in FIG. 1). The image acquired may be a still image or one of a time-resolved series of images—i.e., video. It may be represented in image data of any suitable structure, which is transmitted to the computer. The computer is configured to receive the image data, and in some cases, to enact further processing and/or storage of the image data. The computer may be a personal computer such as a desktop computer, a laptop computer, a game system, or other computing device. In some embodiments, the camera and computer may be integrated together—e.g., in a handheld device such as a smartphone, game device, or media player.

In the illustrated embodiment, camera 12 and computer 14 are connected via data bus 16. The data bus may be a high-speed universal serial bus (USB), in one non-limiting example. More generally, both the camera and the computer may include elements of any suitable wired or wireless high-speed digital interface, so that image data acquired by the camera may be transmitted to the computer for real-time processing.

The cameras disclosed herein are configured to acquire image data representing quantities of radiant energy received in a plurality of spectral bands. Such bands may include a visible wavelength band in addition to one or more invisible wavelength bands—e.g., a UV or IR band. To that end, camera 12 of FIG. 1 includes hyperspectral imagers 18A and 18B, as described in further detail below. Although two hyperspectral imagers are shown in the drawing, other cameras may include only one hyperspectral imager, or more than two.

In some embodiments, the data acquired by camera 12 may be configured (e.g., sufficient in content) to allow conversion into a hyperspectral image. Such conversion may take place at computer 14 or in a logic machine of the camera itself. In a hyperspectral image, each pixel (Xᵢ, Yᵢ) is assigned a color value Cᵢ that spans an invisible wavelength band in addition to one or more visible wavelength bands. The invisible wavelength band may include a UV band, an IR band, or both. In some embodiments, the color value may represent the relative contributions of the three primary-color channels (red, green, and blue, RGB), in addition to a relative intensity in one or more UV or IR channels. For example, the color value may be a four-byte binary value, with the first byte representing intensity in a red channel centered at 650 nanometers (nm), the second byte representing intensity in a green channel centered at 510 nm, the third byte representing intensity in a blue channel centered at 475 nm, and the fourth byte representing intensity in an ultraviolet channel centered at 350 nm. In other embodiments, one or more of the RGB channels may be omitted from the color value, such that some visible-color information is sacrificed to accommodate the UV or IR channel. Thus, a hyperspectral image may encode only grayscale brightness in the visible domain, without departing from the scope of this disclosure.

In some embodiments, the data acquired by camera 12 may be configured (e.g., sufficient in content) to allow conversion into a brightness- or color-coded depth map. Such conversion may take place at computer 14 or in a logic machine of the camera itself. As used herein, the term ‘depth map’ refers to an array of pixels (Xᵢ, Yᵢ) registered to corresponding regions of an imaged subject, with a depth value Zᵢ indicating, for each pixel, the depth of the corresponding region. ‘Depth’ is defined as a coordinate parallel to the optical axis of the camera, which increases with increasing distance from the camera. In a color-coded depth map, a color value Cᵢ may be assigned to each pixel, in addition to the depth value. As noted above, Cᵢ may span some or all of the RGB channels, and may further represent the relative intensity in one or more UV or IR channels.

The nature of cameras 12 may differ in the various embodiments of this disclosure, especially in regard to depth sensing. In one embodiment, two hyperspectral imagers may be included in the camera, displaced relative to each other to acquire stereoscopically related first and second images of a subject. Brightness or color data from the two imagers may be co-registered and combined to yield a depth map.

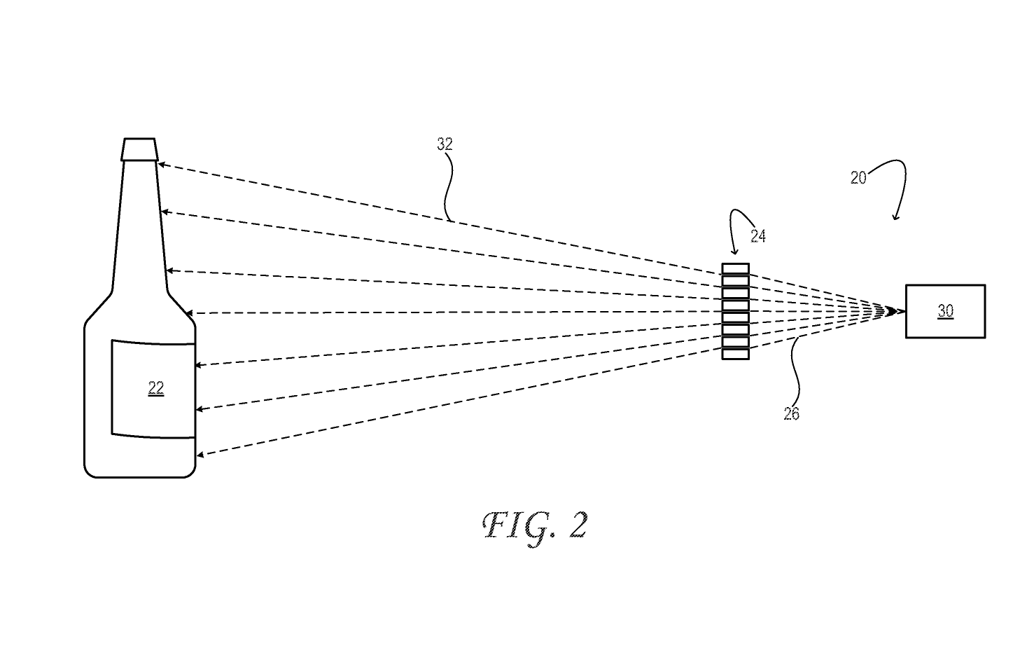

Other depth-sensing embodiments make use of a radiant energy source 20, coupled within the camera. The radiant energy source may be configured to emit radiant energy toward the subject in a particular wavelength band. As shown schematically in FIG. 2, the radiant-energy source may be configured to project on subject 22 a structured UV or IR pattern comprising numerous discrete features—e.g., lines or dots. To that end, the radiant energy source includes a directing optic 24 that receives blanket radiant energy 26 from blanket radiant energy source 30, and directs structured radiant energy 32 toward the subject. Returning briefly to FIG. 1, a hyperspectral imager 18 within camera 12 may be configured to image the structured illumination reflected back from the subject. Based on the spacings between adjacent features in the various regions of the imaged subject, a depth map of the subject may be constructed.

In still other embodiments, radiant energy source 20 may project a pulsed infrared illumination towards the subject. Hyperspectral imagers 18A and 18B may be configured to detect the pulsed illumination reflected back from the subject. Each array may include an electronic shutter synchronized to the pulsed illumination, but the integration times for the arrays may differ, such that a pixel-resolved time-of-flight of the pulsed illumination, from the illumination source to the subject and then to the arrays, is discernible based on the relative amounts of light received in corresponding elements of the two arrays. In such embodiments, the radiant-energy source may emit a relatively short pulse synchronized to an opening of the electronic shutter. In other configurations, a single lens or beam-splitting optic may focus light from the subject on two different sensor arrays.

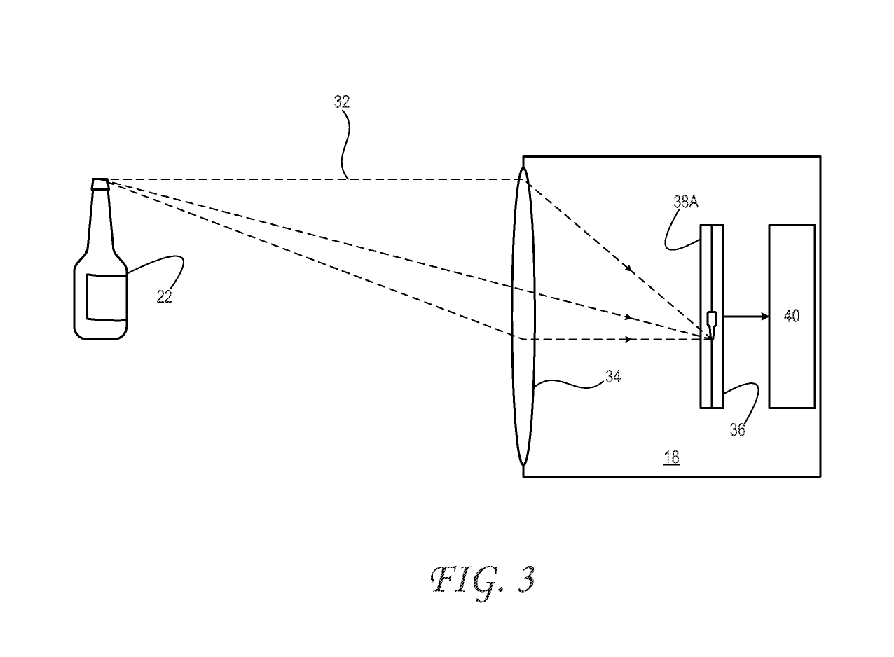

FIG. 3 shows aspects of an example hyperspectral imager 18 in one embodiment. The hyperspectral imager includes lens 34, sensor array 36, filter array 38A, and logic machine 40. The lens is configured to focus an image of subject 22 onto the sensor array. The logic machine is configured to read image data from the sensor array. As each sensor array is configured for hyperspectral imaging of the subject, the image data read by the logic machine may correspond to radiant energy received concurrently in visible and invisible wavelength bands.

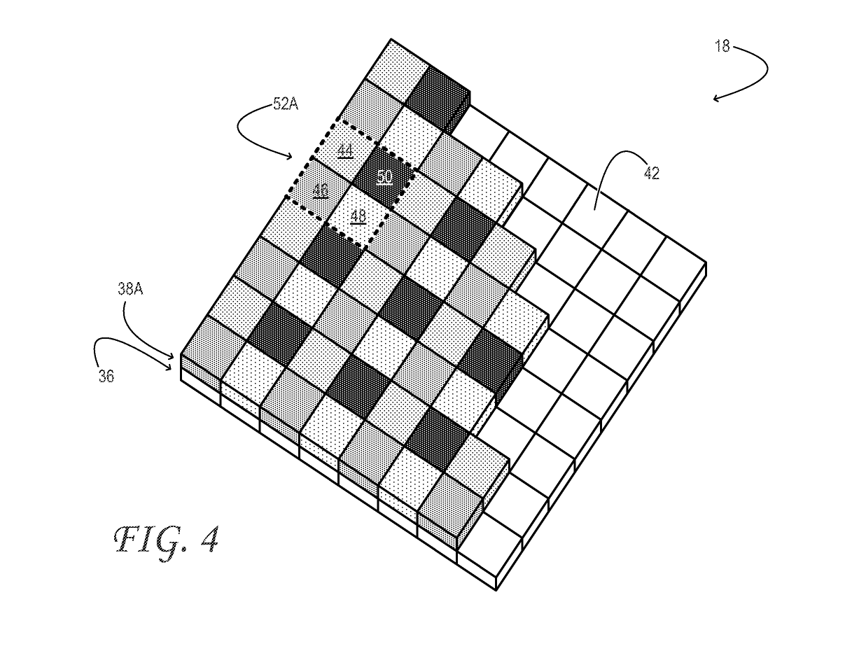

FIG. 4 schematically shows aspects of sensor array 36 and filter array 38A in exemplary detail. The sensor array is an array of individually addressable sensor elements 42, each element responsive to radiant energy received thereon. A sensor element may be ‘responsive to radiant energy’ by virtue of accumulating a quantity of charge, developing an electric potential, or passing an electric current on exposure to the radiant energy, for example. Furthermore, the charge, potential, or current, readable individually for each element of the sensor array, may vary in response to the flux of radiant energy absorbed by that element over a suitable wavelength range. Although FIG. 4 shows only sixty-four sensor elements, an actual sensor array may include virtually any number of sensor elements. In one embodiment, the sensor array may be a complementary metal-oxide-semiconductor (CMOS) array. In another embodiment, the sensor array may be a charge-coupled-device (CCD) array.

Filter array 38A is arranged to filter the radiant energy from the subject en route to sensor array 36. The filter array includes an inhomogeneous tiling of filter elements. As shown in FIG. 4, each filter element of the filter array is arranged in registry with a corresponding sensor element 42 of the sensor array. In the illustrated embodiment, filter and sensor array elements are arranged in a one-to-one ratio, but other registry patterns are envisaged as well. For example, a given filter element may cover two or more sensor elements, in some embodiments.

Each kind of filter element in filter array 38A is configured to transmit radiant energy of a different wavelength band and to reject radiant energy outside that band. A filter element configured to transmit radiant energy in a particular wavelength band need not transmit 100% of the radiant energy in that band. The transmittance of such a filter may peak at 80 to 100% or less in some cases. In other cases, the peak transmittance in the transmission band of a filter element may approach 100%. Likewise, a filter element configured to reject radiant energy outside a particular wavelength band need not reject 100% of the radiant energy in that band. The transmittance of such a filter element outside the indicated transmission band may be less than 20%, less than 10%, or may approach 0% in some cases. Rejection of radiant energy by the filter element may include absorption, reflection, or scattering away from the underlying sensor array. In the illustrated embodiment, the filter array includes an inhomogeneous tiling of four different filter elements: first filter element 44, second filter element 46, third filter element 48, and fourth filter element 50.

In some embodiments, the transmission band of first filter element 44 is invisible and that of the second, third and fourth filter elements are visible. For example, the transmission band of the first filter element may be a UV band or an IR band. Suitable IR bands may include virtually any band of longer wavelength than is perceived by the human eye, including (but not limited to) the so-called near-infrared (NIR) band of about 800 to 2500 nanometers. In some embodiments, the transmission band of the first filter element may be matched to the emission band of radiant energy source 20. This approach may provide an advantage in depth-sensing embodiments in which the source is a narrow-band light-emitting diode, laser, or the like. By providing a sensor channel of a narrow wavelength band that matches the emission band of the source, very significant ambient light rejection may be achieved, for improved signal-to-noise.

Continuing in FIG. 4, second filter element 46 may transmit red light, third filter element 48 may transmit green light, and fourth filter element 50 may transmit blue light. In the illustrated embodiment, one each of the first, second, third, and fourth filter elements are grouped together in a repeating unit cell 52A of filter array 38A. It will be noted however, that the illustrated tiling of filter elements within the unit cell is only one of many possible arrangements, which include positional permutations among the four filter elements. In addition, the unit cell may be larger in some embodiments, including multiple filter elements corresponding to the same transmission wavelength band, but in different positions. Moreover, each transmission wavelength band need not be represented by the same number of filter elements in the unit cell. Rather, the spectral sensitivity of the imager may be tuned by including different numbers of red, green, blue, and UV- or IR-transmissive filter elements in the unit cell.

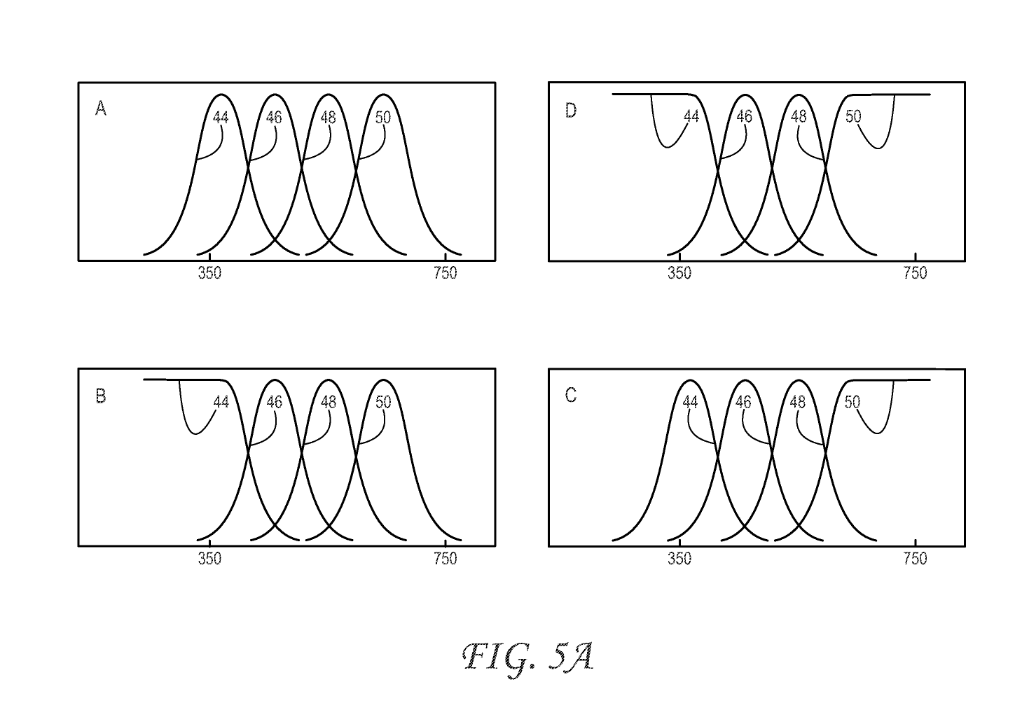

Suitable filter elements for filter array 38A may include band-pass filter elements, high-pass filter elements, and/or low pass filter elements, in various combinations. FIG. 5A summarize some of the possible combinations for a UV-visible filter array. FIG. 5B summarizes analogous combinations for a visible-IR filter array. Each panel shows percent transmittance of incident radiant energy plotted against wavelength for the first, second, third, and fourth filter elements. The unlabelled vertical axis spans the desired transmittance range of 0 to 100 percent. The tick marks on the horizontal axes delimit the approximate, normal wavelength range of human vision in nanometers.

In FIGS. 5A and 5B, panel A represents a filter array in which all four filter elements are band-pass filters. Panel B represents a filter array in which the filter element passing the shortest wavelengths (ultraviolet in FIG. 5A, blue in FIG. 5B) is a low-pass filter, and the rest are band-pass filters. Panel C represents a filter array in which the filter element passing the longest wavelengths (red in FIG. 5A, infrared in FIG. 5B) is a high-pass filter, and the rest are band-pass filters. Panel D represents a filter array in which the shortest wavelengths pass through a low-pass filter, the longest wavelengths pass through a high-pass filter, and band-pass filters pass the intermediate wavelength bands.

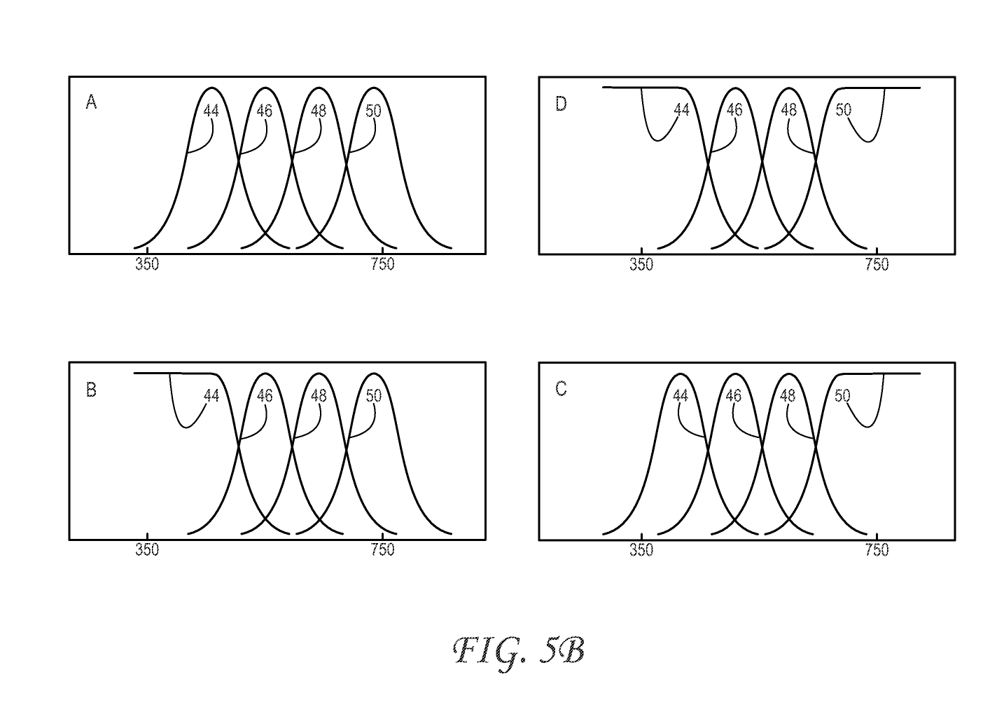

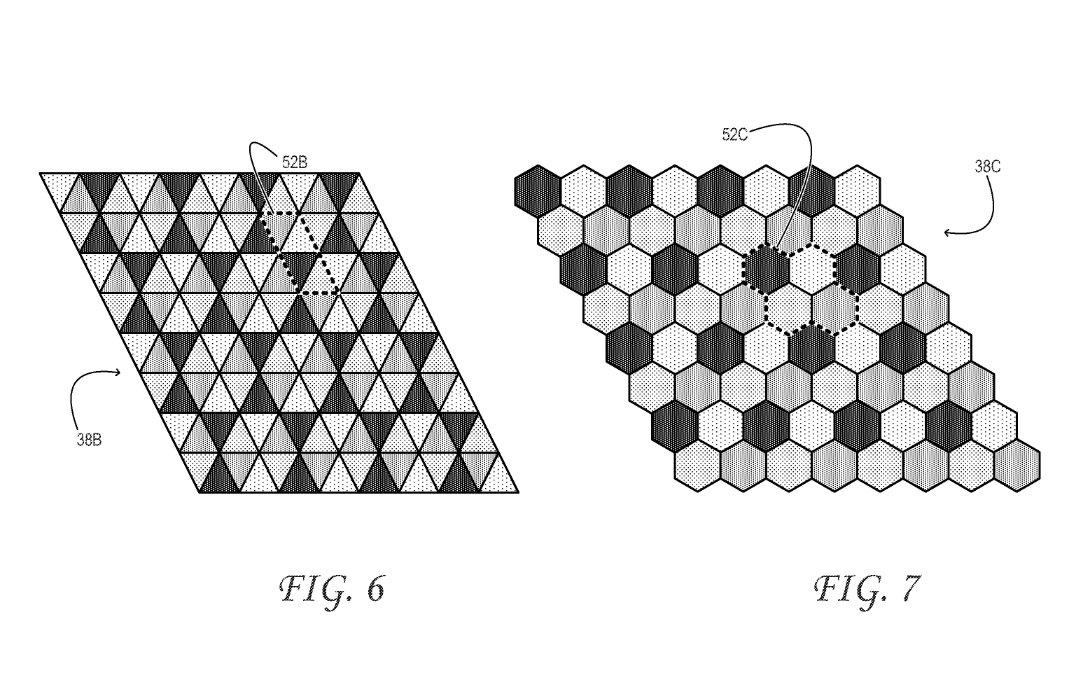

No aspect of the foregoing drawings or description should be interpreted in a limiting sense, for numerous other configurations are contemplated as well. For instance, although FIG. 4 shows an array of rectangular filter elements, alternative geometries may be used instead. These include the triangular filter elements of filter array 38B, in FIG. 6, and the hexagonal filter elements of filter array 38C, in FIG. 7. The unit cells of these filter arrays are denoted 52B and 52C. In such embodiments, the underlying sensor array may include triangular or hexagonal sensor elements.

In additional alternative embodiments, the number of distinct filter elements in the tiling of each filter array need not be equal to four. For example, five or more filter elements may be arranged in each unit cell. To separately detect UV, IR, as well as three RGB channels, for instance, five different filter elements may be included in each unit cell of the filter array. Other embodiments may include as few as two distinct filter elements: a first filter element transmitting radiant energy of an invisible wavelength band and rejecting radiant energy of a visible wavelength band, and a second filter element transmitting radiant energy of the visible wavelength band and rejecting radiant energy of the invisible wavelength band.

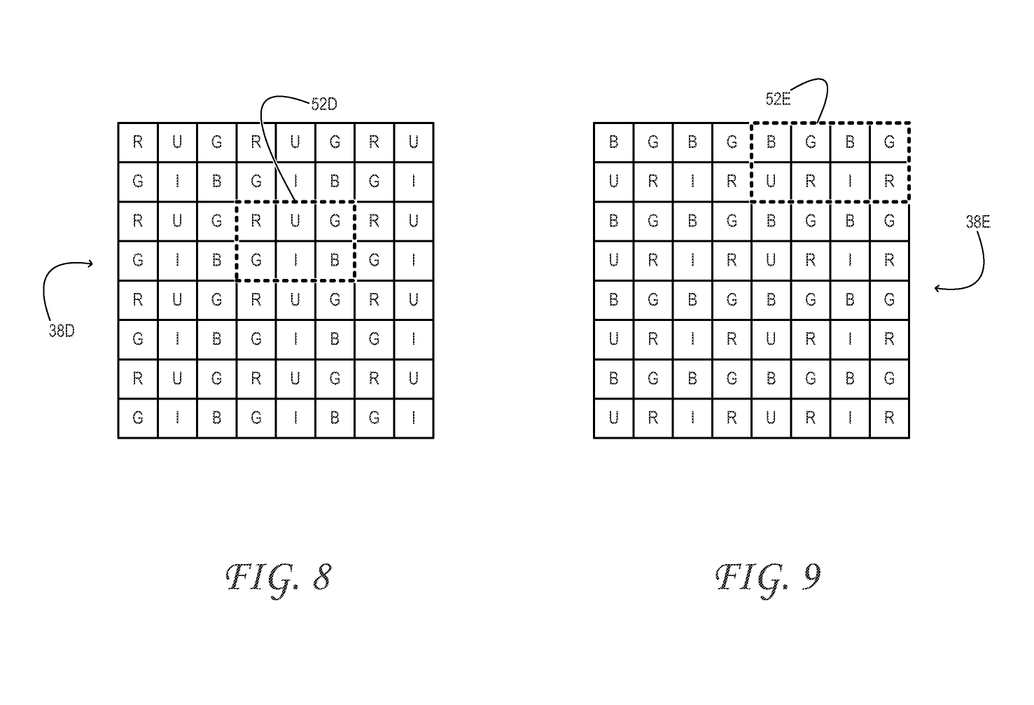

FIG. 8 shows aspects of an example filter array 38D having five different filter elements, for combined UV, IR, and RGB imaging. In this example, the filter elements are rectangular with six elements to each unit cell 52D. For ease of illustration, the five different filter elements are labelled R, G, B, U (for UV-transmissive), and I (for IR-transmissive)—but again, every possible permutation among the filter elements is also contemplated, no matter how many different kinds of filter elements are included in the filter array. In FIG. 8, the unit cell includes two filter elements of one kind (G), and one filter element each for the four remaining kinds. This arrangement may be used to increase the sensitivity of one channel relative to the others. For example, greater sensitivity in the green channel may be desired for color trueness, as human vision is especially sensitive to subtle intensity variations in this region. In other embodiments, the redundant filter element may correspond to a wavelength band in which the underlying sensor array lacks sensitivity—e.g., a band relatively deep in the UV or far into the IR. In still other embodiments, the redundant filter element may correspond to a band that is significantly filtered by upstream optics of the hyperspectral imager.

FIG. 9 illustrates another filter-array embodiment having five different filter elements, for combined UV, IR, and RGB imaging. In filter array 38E, the filter elements are rectangular with eight elements to each unit cell 52E. Here, the red-, green-, and blue-transmissive filter elements are two-fold redundant in each unit cell, while the UV- and IR-transmissive filter elements are non-redundant. This configuration, as well as its many possible permutations, may be used to provide enhanced color sensitivity in a hyperspectral imager.

Some of the camera embodiments here described include two hyperspectral imagers, as shown in FIG. 1. This configuration is useful for stereoscopic and time-of-flight depth sensing, as described hereinabove. However, it also enables combined UV, IR, and RGB imaging with a single camera. For instance, UV and IR filters may be included in the filter arrays of both the left and right imagers. The left array may include UV, IR, red, and green filters; the right array may further include UV, IR, blue, and green filters. In this configuration, both the left and right imagers will yield image data in which UV, IR, and visible contributions are mutually aligned. Although neither the left nor the right imager by itself will produce a true-color image, the two images may be co-registered and combined to yield a ‘stereo-color’ image.

It will be understood that this disclosure also includes any suitable subcombination constructed from the embodiments specifically described or their equivalents. In other words, aspects from one embodiment may be combined with aspects from one or more other embodiments. By way of example, this disclosure fully embraces a filter array having five different filter elements (as in FIG. 8 or 9), but arranged in a hexagonal arrangement (as in FIG. 7).

In some embodiments, the methods and processes described herein may be tied to a computing system of one or more computing devices. In particular, such methods and processes may be implemented as a computer-application program or service, an application-programming interface (API), a library, and/or other computer-program product.

Imaging system 10 of FIG. 1 is one, non-limiting example of a computing system that can enact one or more of the methods and processes described above. In other examples, the computing system may include more than one computer. It may take the form of one or more personal computers, server computers, tablet computers, home-entertainment computers, network computing devices, gaming devices, mobile computing devices, mobile communication devices (e.g., a smart phone), and/or other computing devices. The computing system may optionally include a display subsystem, an input subsystem, a communication subsystem, and/or other components.

As shown in FIG. 1, computer 14 of imaging system 10 includes a logic machine 40B and a storage machine 54. Hyperspectral imager 18 includes a logic machine 40A, as shown in FIG. 3, and may also include a storage machine. Logic machine 40B includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 54 includes one or more physical devices configured to hold instructions executable by the logic machine to implement the methods and processes described herein. When such methods and processes are implemented, the state of storage machine 54 may be transformed—e.g., to hold different data.

Storage machine 54 may include removable and/or built-in devices. Storage machine 54 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 54 may include volatile, nonvolatile, dynamic, static, read/write, read-only, random-access, sequential-access, location-addressable, file-addressable, and/or content-addressable devices.

It will be appreciated that storage machine 54 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 40B and storage machine 54 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, a display subsystem may be used to present a visual representation of data held by storage machine 54. This visual representation may take the form of a graphical user interface (GUI). As the herein described methods and processes change the data held by the storage machine, and thus transform the state of the storage machine, the state of the display subsystem may likewise be transformed to visually represent changes in the underlying data. The display subsystem may include one or more display devices utilizing virtually any type of technology. Such display devices may be combined with logic machine 40B and/or storage machine 54 in a shared enclosure, or such display devices may be peripheral display devices.

When included, an input subsystem may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or camera for machine vision and/or gesture recognition; a head tracker, eye tracker, accelerometer, and/or gyroscope for motion detection and/or intent recognition; as well as electric-field sensing componentry for assessing brain activity.

When included, a communication subsystem may be configured to communicatively couple the computing system with one or more other computing devices. The communication subsystem may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow the computing system to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A depth-sensing camera comprising:
a sensor array of individually addressable sensor elements, each element responsive to radiant energy received from a subject; and
a filter array arranged to filter the radiant energy en route to the sensor array, the filter array including an inhomogeneous tiling of first, second, third, and fourth filter elements, each filter element transmitting radiant energy of a different wavelength band and rejecting radiant energy outside that band, the band of the first filter element being invisible and that of the second, third and fourth filter elements being visible; and
a radiant-energy source emitting radiant energy toward the subject in the first wavelength band.

2. The camera of claim 1 wherein the radiant-energy source includes a directing optic to direct structured radiant energy onto the subject.

3. The camera of claim 1 wherein the first filter element includes a band-pass filter element.

4. The camera of claim 1 wherein the band of transmission of the first filter element is an ultraviolet wavelength band.

5. The camera of claim 1 wherein the band of transmission of the first filter element is an infrared wavelength band.

6. A hyperspectral imager comprising:
a sensor array of individually addressable sensor elements, each element responsive to radiant energy received thereon; and
a filter array arranged to filter the radiant energy en route to the sensor array, the filter array including an inhomogeneous tiling of first and second filter elements, the first filter element transmitting radiant energy of an invisible wavelength band and rejecting radiant energy of a visible wavelength band, the second filter element transmitting radiant energy of the visible wavelength band and rejecting radiant energy of the invisible wavelength band.

7. The imager of claim 6 wherein each filter element of the filter array is arranged in registry with a corresponding sensor element of the sensor array.

8. The imager of claim 6 wherein the tiling further includes third and fourth filter elements, and wherein each of the first, second, third, and fourth filter elements transmits radiant energy of a different wavelength band and rejects energy outside that band.

9. The imager of claim 8 wherein the second filter element transmits red light, the third filter element transmits green light, and the fourth filter element transmits blue light.

10. The imager of claim 9 wherein the tiling further includes a fifth filter element, wherein the first filter element transmits in an ultraviolet wavelength band, and wherein the fifth filter element transmits in an infrared wavelength band.

11. The imager of claim 8 wherein one each of the first, second, third, and fourth filter elements are grouped together in a repeating unit cell of the filter array.

12. The imager of claim 6 wherein the sensor array is a complementary metal-oxide-semiconductor (CMOS) or charge-coupled-device (CCD) array.

13. A camera comprising:
a sensor array of individually addressable sensor elements, each element responsive to radiant energy received from a subject;
a filter array arranged on the sensor array to filter the radiant energy en route to the sensor array, the filter array including an inhomogeneous tiling of first and second filter elements, the first filter element transmitting radiant energy of an invisible wavelength band and rejecting radiant energy of a visible wavelength band, the second filter element transmitting radiant energy of the visible wavelength band and rejecting radiant energy of the invisible wavelength band; and
a logic machine to read data from the sensor array, the data representing radiant energy received concurrently in each of the visible and invisible wavelength bands.

14. The camera of claim 13 further comprising an interface to transmit the data to a computer.

15. The camera of claim 14 wherein the data is configured to enable conversion into a hyperspectral image.

16. The camera of claim 14 wherein the data is configured to enable conversion into a brightness- or color-coded depth map.

17. The camera of claim 13 wherein the sensor array is a first of two sensor arrays, and wherein the filter array is a first of two, corresponding filter arrays.

18. The camera of claim 17 further comprising a radiant-energy source configured to emit a narrow pulse of radiant energy, wherein the first and second sensor arrays each include an electronic shutter whose opening is synchronized to the narrow pulse, and wherein the electronic shutter of the first filter array is held open longer than the electronic shutter of the second sensor array.

19. The camera of claim 17 wherein the first and second sensor arrays are displaced relative to each other to acquire stereoscopically related first and second images of the subject.

20. The camera of claim 13 wherein the tiling further includes third and fourth filter elements, wherein each of the first, second, third, and fourth filter elements transmits radiant energy of a different wavelength band and rejects energy outside that band, and wherein the invisible wavelength band is an infrared wavelength band.
